(19) United States
(12) Patent Application Publication
(10) Pub. No.: US 2012/0125197 A1
(43) Pub. Date: May 24, 2012

(54) DECONTAMINATION APPARATUSES AND METHODS

(75) Inventors: Szu-Min Lin, Irvine, CA (US); Robert C. Platt, JR., Temecula, CA (US); Robert G. Lukasik, Lake Elsinore, CA (US); Kayyani C. Adiga, Macon, GA (US); Rajani Adiga, Macon, GA (US); Robert F. Hatcher, JR., Macon, GA (US)

(73) Assignee: Ethicon, Inc., Somerville, NJ (US)

(21) Appl. No.: 12/951,818

(22) Filed: Nov. 22, 2010

(51) Int. Cl. B01D 47/06

(52) U.S. Cl. 95/227; 261/158

(57) ABSTRACT

A decontamination apparatus is disclosed. The decontamination apparatus comprises a mist generator configured to generate a mist, a first conduit in fluid communication with the mist generator and configured to receive the mist, a stream movement device configured to move a stream, and a heating device configured to heat the stream moved by the stream movement device. The decontamination apparatus comprises a second conduit in fluid communication with the stream movement device and configured to receive the heated stream. The first conduit comprises a first outlet configured to pass the mist therethrough and the second conduit comprises a second outlet configured to pass the heated stream therethrough. The second outlet is positioned proximate to the first outlet. A portion of the mist evaporates into a vapor for decontamination of an environment when mixed with the heated stream outside of the first outlet, the second outlet, and the decontamination apparatus.

### FIELD

The present disclosure relates generally to apparatuses and methods for decontamination and, more particularly, relates to apparatuses and methods for decontamination of an environment through the production of vapor at least partially within the environment.

### BACKGROUND

Mists and/or vapors may be used to decontaminate rooms, environments, areas, and/or chambers, for example. Contact by the mists and/or vapors with surfaces and/or articles in the rooms, environments, areas, and/or chambers may decontaminate the surfaces and/or the articles. In various embodiments, vapors may be created within decontamination apparatuses and then provided to the rooms, environments, areas, and/or chambers for decontamination of the surfaces and/or the articles. In most industrial processes, vapors are produced by flash vaporization (i.e., heating above the boiling point) of a solution or a liquid on a hot plate or similar heat source. These vapors, owing to their creation at or over the boiling point of the solution or the liquid, exit the decontamination apparatus at very high temperatures. Furthermore, if a large quantity of vapor is desired for a large area to be treated, a large hot plate or a large heat source is usually provided because of the heat loss and the added heat capacity of the large hot plates and large heat source. Such large hot plates or large heat sources use a significant amount of energy because of inefficient heating methods. What is needed is an improvement in vapor production techniques.

### SUMMARY

In one general aspect, the present disclosure is directed, in part, to a decontamination apparatus. The decontamination apparatus comprises a first conduit in fluid communication with a mist generator and configured to receive a mist and a second conduit in fluid communication with a stream movement device, and configured to receive a heated stream. The first conduit comprises a first outlet configured to pass the mist therethrough and the second conduit comprises a second outlet configured to pass the heated stream therethrough. The second outlet is positioned proximate to the first outlet. At least a portion of the mist evaporates into a vapor for decontamination of an environment when mixed with the heated stream outside of the first outlet, the second outlet, and the decontamination apparatus.

In one general aspect, the present disclosure is directed, in part, to a decontamination apparatus. The decontamination apparatus comprises a first conduit configured to receive a mist from a mist generator, a second conduit configured to receive a heated stream from a stream movement device, a first outlet at an end of the first conduit, and a second outlet at an end of the second conduit. The first outlet is configured to pass the mist therethrough and the second outlet is configured to pass the heated stream therethrough, such that the heated stream is mixed with the mist outside of the first outlet and the second outlet to form a vapor for decontamination of an environment.

In another general aspect, the present disclosure is directed, in part, to a decontamination method using a decontamination apparatus. The method comprises the steps of generating a mist from a mist generator, generating a stream from a stream movement device, heating the stream by a heating device, flowing the mist through a first conduit comprising a first outlet, and flowing the heated stream through a second conduit comprising a second outlet. The first outlet is positioned proximate to the second outlet. The method further comprises the step of mixing the mist with the heated stream proximate to the first outlet and the second outlet to form a mixing zone. At least a portion of the mixing zone is outside of the decontamination apparatus. The method further comprises the steps of producing vapor by evaporating the mist with the heated stream, and decontaminating at least a portion of an environment with at least a portion of the vapor.

It should be understood that the present disclosure is not limited to the embodiments disclosed in this Summary, but it is intended to cover modifications that are within the spirit and scope of the disclosure, as defined by the claims.

### BRIEF DESCRIPTION OF THE FIGURES

Various non-limiting embodiments of the present disclosure are described herein in conjunction with the following figures, wherein:

FIG. 1A is a schematic illustration of a decontamination apparatus in accordance with one non-limiting embodiment of the present disclosure;

FIG. 1B is a schematic illustration of another decontamination apparatus in accordance with one non-limiting embodiment of the present disclosure;

FIG. 2A is a schematic illustration of yet another decontamination apparatus in accordance with one non-limiting embodiment of the present disclosure;

FIG. 2B is a schematic illustration of still another decontamination apparatus in accordance with one non-limiting embodiment of the present disclosure;

FIG. 2C is a top view of the decontamination apparatus of FIG. 2B in accordance with one non-limiting embodiment of the present disclosure;

FIG. 3 is a schematic illustration of still another decontamination apparatus in accordance with one non-limiting embodiment of the present disclosure;

FIG. 4 is a schematic illustration of a decontamination apparatus being used in an area application in accordance with one non-limiting embodiment of the present disclosure;

FIG. 5A is a schematic illustration of a decontamination apparatus being used in a chamber application in accordance with one non-limiting embodiment of the present disclosure;

FIG. 5B is a schematic illustration of a decontamination apparatus being used in a chamber application in accordance with one non-limiting embodiment of the present disclosure;

FIG. 6 is a schematic illustration of an outlet of a decontamination apparatus in accordance with one non-limiting embodiment of the present disclosure;

FIG. 7 is a schematic illustration of another outlet of a decontamination apparatus in accordance with one non-limiting embodiment of the present disclosure;

FIG. 8 is a perspective view of a decontamination apparatus in accordance with one non-limiting embodiment of the present disclosure;

FIG. 9 is a perspective view of a decontamination apparatus comprising multiple outlets in accordance with one non-limiting embodiment of the present disclosure; and

FIG. 10 is a perspective view of a box-type inlet assembly configured for use with the various decontamination apparatuses of the present disclosure in accordance with one non-limiting embodiment.

### DETAILED DESCRIPTION

Various non-limiting embodiments of the present disclosure will now be described to provide an overall understanding of the principles of the structure, function, manufacture, and use of decontamination apparatuses and/or decontamination methods. One or more examples of these non-limiting embodiments are illustrated in the accompanying drawings. It will be appreciated that the decontamination apparatuses and decontamination methods specifically described herein and illustrated in the accompanying drawings are non-limiting example embodiments and that the scope of the various non-limiting embodiments of the present disclosure are defined solely by the claims. The features illustrated or described in connection with one non-limiting embodiment may be combined with the features of other non-limiting embodiments. Such modifications and variations are intended to be included within the scope of the present disclosure.

The term “mist” means a substance that is comprised of small droplets of liquid. Mist vaporizes or evaporates into vapor. Mist does not condense. Mist may be generated with an ultrasound humidifier or other suitable mist or liquid droplet generating devices, for example. Depending on the size and density of the small droplets of liquid, mist is generally visible to the naked eye.

The term “vapor” means a gas that is comprised of free molecules. Vapor condenses. Vapor is produced from the evaporation of a mist or liquid.

The term “decontamination” means the inactivation of bio-contamination, and comprises, but is not limited to, sanitization, sterilization, and disinfection. Decontamination also includes the inactivation of prions, protozoal oocysts, bacterial endospores, mycobacteria, viruses, fungal spores, vegetative bacteria, and mycoplasmas, for example.

The term “environment” means an open area, a contained area of gas or air, a closed area, a room, an isolator, a chamber, an enclosure, a shelter, a nursery, a day-care or any suitable space, place, and/or area that may require decontamination. The term “environment” also comprises the surfaces, equipment, devices, toys, beds, tables, and/or any other articles in the space, place, and/or area. Depending on the concentration of germicidal chemicals and applications, the term “environment” may also comprise people, patients, healthcare workers, poultry, and/or animals within the space, place, and/or area.

In one embodiment, a decontamination apparatus of the present disclosure may create a vapor by mixing, or turbulently mixing, a mist and a heated stream. Turbulent mixing is generally a fluid regime that is characterized by chaotic, stochastic property fluctuations, such as velocity, pressure temperature, and concentration, for example. Additional details regarding turbulent mixing is described in Madjid Birouk and Iskender Gokalp, “Current status of droplet evaporation in turbulent flows,” Progress in Energy and Combustion Science, 32, 408-423 (2006), which is incorporated by reference herein in its entirety. Turbulence in a mixing zone between the mist and the heated stream may be used to create optimal mixing and efficient evaporation of the mist into a vapor. The mist may be comprised of a single or multiple component decontamination liquid or solution, such as water, miscible solutions of water and alcohols, biocides, such as hydrogen peroxide, organic compounds, peracetic acid, performic acid, other peracid chemical, ozonized liquid, chlorine compounds, hypochlorite, quaternary ammonium compounds, and mixtures thereof, oils and their blends, and/or fuels, such as petroleum distillates and their blends (e.g., kerosene), for example. The heated stream may be comprised of gases, such as air from an environment in which the decontamination apparatus is positioned, air not from the environment in which the decontamination apparatus is positioned, ozone, chlorine dioxide, nitrogen dioxide, carbon dioxide, and/or inert gases, such as nitrogen, and helium, for example. In various embodiments, the vapor creation process may occur within, or at least partially within, an environment to be decontaminated or, in other embodiments, may occur within a decontamination apparatus and then be provided to the environment to be decontaminated. In any event, the mist may be mixed, or turbulently mixed, with the heated stream causing the creation or production of the vapor owing to evaporation of the mist resulting from the mixing with the heated stream. The percentage of conversion of the mist to a vapor with the decontamination apparatuses of the present disclosure may be greater than about 25%, greater than about 35%, greater than about 50%, greater than about 60%, or greater than about 75%. In one embodiment, the percentage of conversion of the mist to a vapor may be about 80% or greater. In another embodiment, the conversion of the mist to a vapor may be 100%. The conversion of the mist to a vapor may be controlled by the rate of mist flow and/or the temperature of the heated stream. The rate of mist flow and/or the temperature of the heated stream may be varied with a suitable variable transformer obtainable from Staco Energy Products Co., for example. In high mist to vapor conversion rate embodiments, the rate of mist flow may be lowered and/or the temperature of the heated stream may be increased, for example. In various embodiments, mist conversion to a vapor may occur outside of the decontamination apparatus and/or in an environment to be treated. In such an embodiment, the mist and the heated stream may remain separate while within the decontamination apparatus and only be mixed upon or shortly after their exit from the decontamination apparatus. In other various embodiments, the mist and the heated stream may remain separate within the decontamination apparatus until they approach an outlet of a first conduit and an outlet of a second conduit. The mist and the heated stream may then be turbulently mixed proximate to the outlets, but within a portion of the decontamination apparatus, to create a vapor. The vapor may then travel through a conduit of the decontamination apparatus that is open to an environment to be decontaminated. In one embodiment, the vapor may be created at least partially within the environment to be treated.

In various embodiments, large quantities of vapor may be created with minimal energy consumption owing to the heated stream being mixed or turbulently mixed with the mist to create the vapor through evaporation. As such, a large heat source or a large hot plate with added heat losses and storage may not be required. The quantity of vapor produced by the decontamination apparatus is easily scalable for any environment by merely operating the decontamination apparatus for a longer period of time, as the vapor may be consistently produced as long as the mist and the heated stream are being generated and mixed appropriately. Further, through the use of the heated stream and the mist, the vapor may be produced below the boiling temperature of the mist liquid or solution through evaporation, thereby leading to a produced vapor that has a temperature at or near ambient temperature, for example. In one embodiment, the vapor temperature may be about 1 to about 50 degrees C., about 2 to about 30 degrees C., or about 3 to about 10 degrees C. higher than ambient temperature of the environment, for example. The temperature of heated stream may be varied based on the amount of mist that needs to be evaporated into vapor. The produced vapor may be thermally stable. Also, production of the vapor below the boiling point of the mist liquid or solution may enable the chemistry of the mist liquid or solution to be preserved through avoidance of excessive heat used during the vapor creation process. Stated another way, production of the vapor below the boiling point of the mist liquid or solution may reduce the chance that distillation of the components in binary and multi-component mist droplets, such as an ethanol and water solution and a water and hydrogen peroxide solution, will occur. In some instances, this may be an important consideration in the evaporation of mist droplets for decontamination, odor removal, and chemical and biological neutralization processes using vapors. In one embodiment, the larger the temperature differential between the mist and the heated stream, the faster the mist may evaporate, although it may be undesirable to greatly overheat the environment above the ambient temperature of the environment by using too large of a temperature differential between the mist and the heated stream. In various embodiments, the temperature and/or flow rate of the heated stream and/or the temperature and/or the flow rate of the mist may be varied to achieve desired vapor production. In one embodiment, the temperature of the heated stream may be about 30 to about 150 degrees C., about 40 to about 100 degrees C., about 50 to about 80 degrees C., or about 60 to about 70 degrees C., for example.

In various embodiments, the mist may be comprised of fine mist droplets that may be produced from ultrasonic atomization, thereby leading to a higher mist to vapor conversion rate. These fine mist droplets may evaporate when mixed with the heated stream using convection methods by discharging the mist into an environment to be decontaminated that has initial adequate enthalpy available to evaporate the desired quantity of the mist droplets. In other embodiments, the mist may evaporate by convection methods when provided to a heated or warmed environment. In various embodiments, the air in the environment may be heated about 30 to about 150 degrees C., about 40 to about 100 degrees C., about 50 to about 80 degrees C., or about 60 to about 70 degrees C., for example. The appropriate temperature for the heated stream may be calculated by the volume of the mist or the mist flow rate. The heating or warming of the environment to be treated may be accomplished by drawing air into the decontamination apparatus, heating the air, and returning the air to the environment to be treated. In other embodiments, the mist may be entrained by a swirling heated stream. In still other embodiments, a fine mist of less than about 10-20 micron, or about 5-10 micron diameter droplets flowing at a low velocity may be entrained into a heated stream flowing at a relatively high velocity to create the vapor. Such a process may provide mist to vapor conversion times or evaporation times as short as milliseconds in some instances. In other various embodiments, the mist to vapor conversion times may be within a period of seconds, depending on the droplet size and droplet distribution.

In various embodiments, the efficiency of evaporation of the mist may be dependent on the intimate mixing of the heated stream and the mist. Various parameters may be controlled or adapted to achieve proper conditions for vapor production. These parameters may comprise the enthalpy of the heated stream, the relative humidity of the heated stream, the temperature of the heated stream, the relative velocities of the heated stream and the mist, the number density of the mist, and/or the subsequent localized humidity at the entrained mist droplet level.

In various embodiments, the present disclosure provides methods to vary the above-referenced parameters to suit the particular input mist characteristics, the desired vapor temperature, the desired vapor concentration, and/or the desired vaporization time scales. By varying the relative velocities of the heated stream and the mist, the role of convective force in the evaporation process may be enhanced or diminished. By varying the temperature and enthalpy of the heated stream, the role of heat may be enhanced or diminished in the evaporation process. By varying the volume of the heated stream, the expansion of the mixing mist and the heated stream into an environment and the number density and localized background humidity at the mist droplet level may be controlled to enhance or diminish the role of this parameter in the evaporation process. In one embodiment, the present disclosure provides an evaporation process that comprises two distinct streams; a slow moving mist stream and a fast moving heated stream. These two streams may be configured and directed to collide or intersect with each other to optimize the entrainment, mixing, and/or enhance heat and mass transfer yielding efficient evaporation of the mist to a vapor.

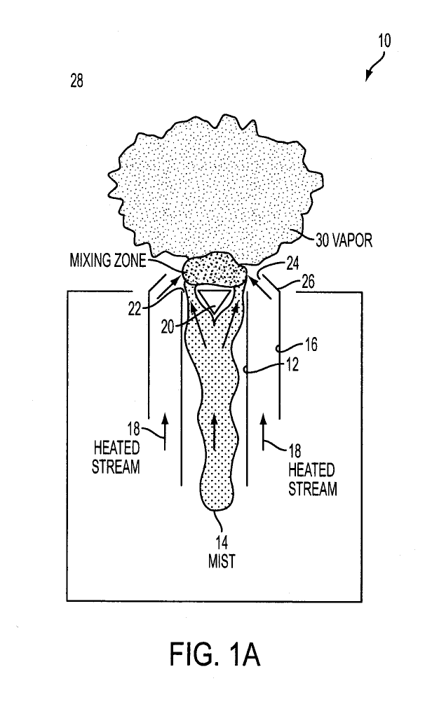

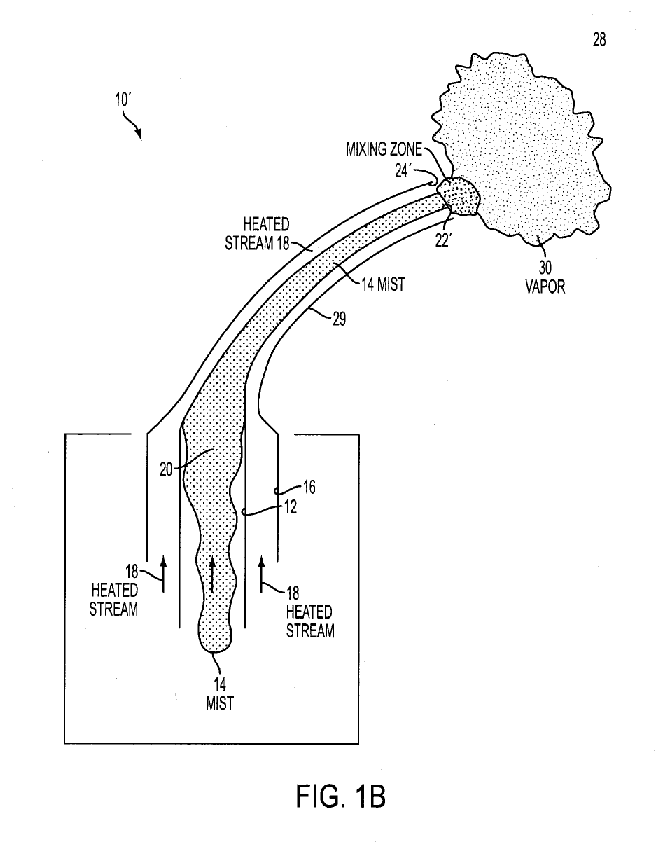

In one embodiment, referring to FIG. 1A, a schematic illustration of a decontamination apparatus 10 is provided. In addition to the features described below, the decontamination apparatus 10 may comprise a mist generator, a mist movement device, at least one heating device, and at least one stream movement device, although such components are not illustrated in FIG. 1A for simplicity. The decontamination apparatus 10 may comprise a first conduit 12 in fluid communication with a mist generator and configured to receive a mist 14 and a second conduit 16 in fluid communication with a stream movement device and configured to receive a stream, such as a heated stream 18, for example. A mist diverter 20 may be positioned at least partially within or proximate to a first outlet 22 of the first conduit 12. The second conduit 16 may comprise a second outlet 24 positioned proximate to or offset from the first outlet 22. The first outlet 22 may be configured to pass the mist 14 therethrough and the second outlet 24 may be configured to pass the heated stream 18 therethrough. In one embodiment, the second conduit 16 may at least partially surround the first conduit 12 and/or the first conduit 12 may be concentric with the second conduit 16. In one embodiment, the second outlet 24 may comprise a heated stream diverter 26 angled or rounded toward the first conduit 12. The first and second conduits 12 and 16 may each comprise, from a cross-sectional standpoint taken perpendicular to a longitudinal axis of the first conduit 12, annular portions, arcuate portions, semi-circular portions, circular portions, rectangular portions, and/or square portions, for example. In one embodiment, the first and second conduits 12 and 16 may comprise rounded portions at intersections of walls thereof to maintain proper, more laminar flow of the mist 14 and the heated stream 18, while each is within their respective conduits. In various embodiments, the flow rate of the mist 14 may be lower than the flow rate of the heated stream 18. In other various embodiments, the flow rate of the mist 14 may be the same as the flow rate of the heated stream 18. In various embodiments, the flow rate of the mist 14 and/or the heated stream 18 may be constant or continuously variable. In one embodiment, the flow rate of the mist 14 and/or the heated stream 18 may also be intermittent.

In one embodiment, referring again to FIG. 1A, the mist 14 may be turbulently mixed with the heated stream 18 as each of the mist 14 and the heated steam 18 exit their respective outlets 22 and 24 or after the mist 14 and the heated stream 18 exit their respective outlets 22 and 24. In one embodiment, such mixing may occur within, or at least partially within, an environment 28 to be treated or decontaminated. In any event, the mixing may occur outside of or proximate to the first outlet 22 and the second outlet 24. Upon turbulently mixing the mist 14 with the heated stream 18, at least most of the mist 14 may be converted into a vapor 30 in the environment 28 to be treated or decontaminated. In one embodiment, the mist 14 may exit the first outlet 22 perpendicular to, or substantially perpendicular to, the heated steam 18 exiting the second outlet 24. In other various embodiments, the mist 14 may exit the first outlet 22 in a transverse fashion with respect to the heated stream 18 exiting the second outlet 24. The mist diverter 20 and the heated stream diverter 26 may be configured to cause the heated stream 18 to intersect with the mist 14. Such flow of the mist 14 relative to the heated stream 18 may cause turbulent mixing between the mist 14 and the heated stream 18. Although it is described above that the vapor 30 is created within the environment 28 to be treated or decontaminated, it should be recognized that, in one embodiment, the outlets 22 and 24 could be positioned inside a tube, conduit, housing, or other structural member that is open to the environment 28 to be decontaminated, such that the mist 14 and the heated stream 18 are mixed outside of, or proximate to, the first and second outlets 22 and 24 to create a vapor at least partially within or proximate to the decontamination apparatus 10. The vapor may then be provided to the environment 28 using the tube, conduit, housing or other structural member.

In one embodiment, referring to FIG. 1B, a decontamination apparatus 10′ is provided. The decontamination apparatus 10′ may comprise similar features as the decontamination apparatus 10 and may also comprise a conduit 29 in fluid communication with the first conduit 12 and the second conduit 16. The conduit 29 may be flexible or have flexible portions and may be an extension of the first conduit 12 and the second conduit 16. In such an embodiment, the mist 14 and the heated stream 18 may still remain separate when within the conduit 29 until each reaches the outlets 22′ and 24′ of the conduit 29. In one embodiment, the decontamination apparatus 10′ may be designed, built, and/or used as a portable unit for decontamination. If there is a spill or unsanitary condition in the environment 28, the decontamination apparatus 10′ may be used to treat the spill or unsanitary condition instead of decontaminating the entire environment 28. The decontamination apparatus 10′ may also be used to treat a small area, such as a playground, for example, in an open environment, such as a park, for example.

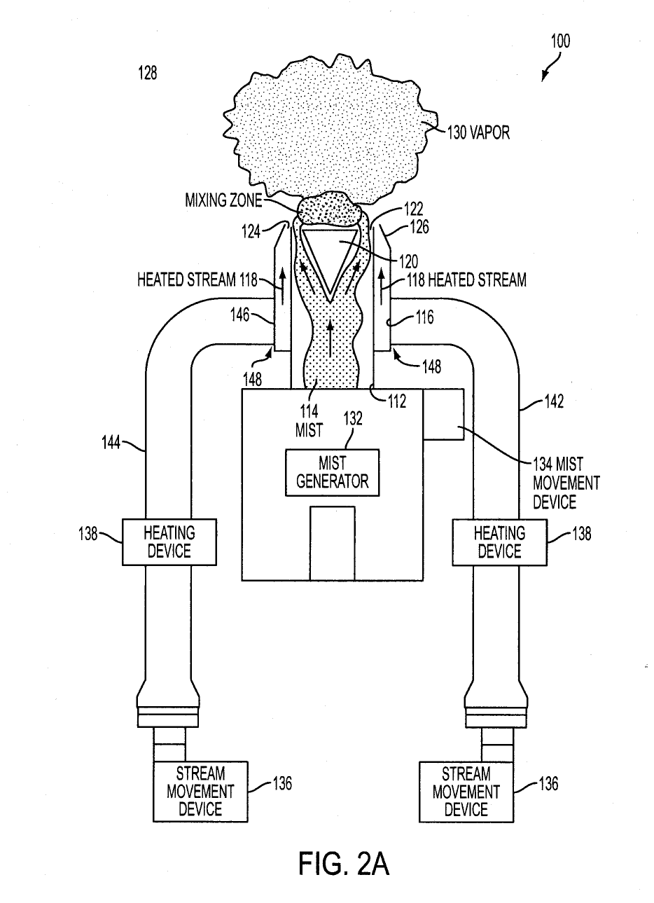

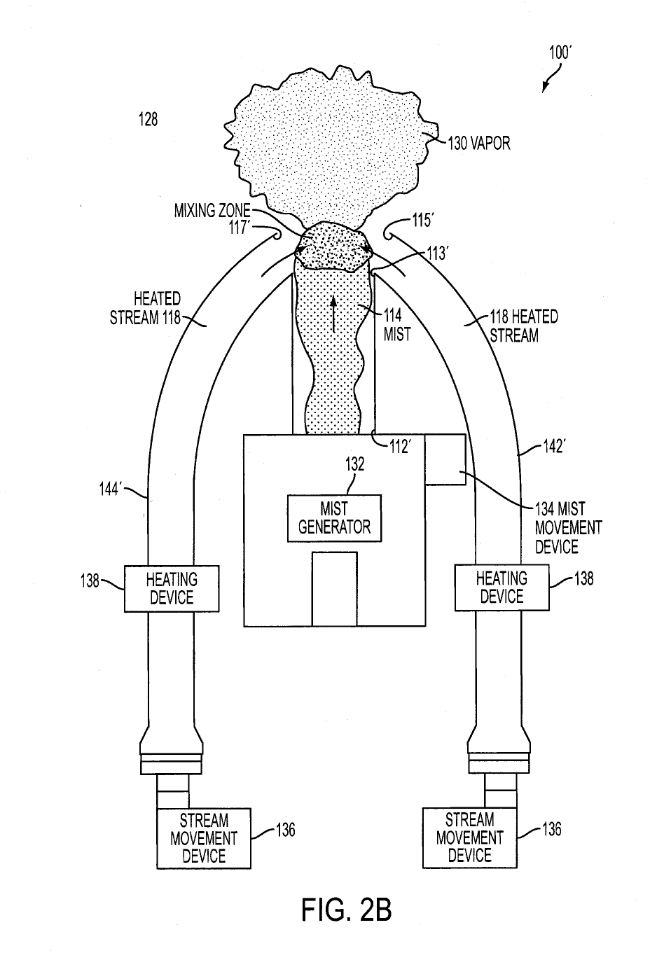

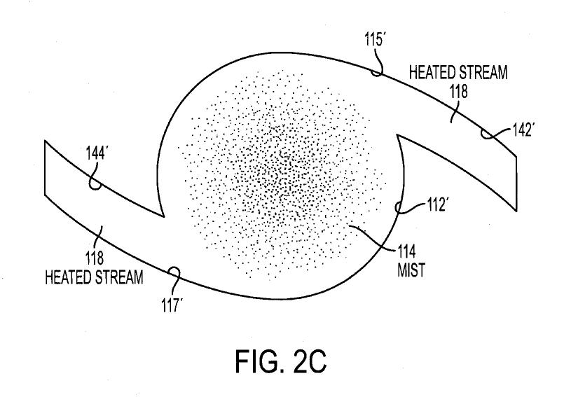

In one embodiment, referring to FIG. 2A, a decontamination apparatus 100 may comprise a first conduit 112 comprising a first outlet 122 and a second conduit 116 comprising a second outlet 124. The first conduit 112 and the first outlet 122 may be similar to the first conduit 12 and the first outlet 22 described above with respect to FIG. 1A. Likewise, the second conduit 116 and the second outlet 124 may be similar to the second conduit 16 and the second outlet 24 described above. In various embodiments, a mist diverter 120 may be positioned within, at least partially within, or proximate to the first outlet 122 of the first conduit 112 and the second outlet 124 may comprise a heated stream diverter 126 angled toward or rounded toward the first conduit 112, similar to that described above. The mist diverter 120 and the heated stream diverter 126 may comprise any suitable shape, size, and/or configuration.

In one embodiment, again referring to FIG. 2A, the decontamination apparatus 100 may comprise at least one mist generator 132 configured to generate a mist 114, at least one mist movement device 134 in fluid communication with the mist generator 132 and configured to move the mist 114 into the first conduit 112, at least one stream movement device 136 configured to move at least one stream and in fluid communication with the second conduit 116, and at least one heating device 138 configured to heat the stream moved by the at least one stream movement device 136. The various components may be positioned within a housing (not illustrated in FIG. 2A). The housing may define various apertures therein; one proximate to the first and second outlets 122 and 124 and at least one near the stream movement devices or at least in fluid communication with the stream movement devices, such that a gas may be drawn into the housing, through the apertures, by the stream movement devices and then used to generate the heated stream 118.

In one embodiment, still referring to FIG. 2A, the mist generator 132 may be any conventional mist or liquid droplet generating apparatus known to those of skill in the art. In various embodiments, the mist generator 132 may generate a fine mist of less than about 1-20 micron, about 1-10 micron, about 1-5 micron, or about 5-10 micron diameter mist droplets. In one embodiment, the mist may be mono-dispense. In various embodiments, a commercially available mist generator, such as mister maker fogger by Mainland Mart, for example, may be used to generate the mist 114. In various embodiments, the mist generator may comprise an ultrasound humidifier or any other suitable mist generator known to those of skill in the art. In one embodiment, an additional heating device and stream movement device may also be provided for preconditioning of an environment 128, for example.

In one embodiment, still referring to FIG. 2A, the mist movement device 134 may be used to move the mist 114 from the mist generator 132 to the first conduit 112 or, in other embodiments, to other various conduits. The mist movement device 134 may comprise a fan, blower, and/or other suitable device configured to move the mist 114. In other various embodiments, the mist movement device 134 may merely be an opening in the mist generator 132 and a vacuum created by movement of the heated stream 118 in a direction away from, or substantially away from, the first outlet 122. Such movement of the heated stream 118 may create a vacuum in or proximate to the first outlet 122 and the first conduit 112. Owing to the fact that the first conduit 112 is in fluid communication with the mist generator 132, the mist 114 may be pulled into the first conduit 112 and pulled through the first outlet 122 when the heated stream 118 is moving because of the vacuum created by the movement of the heated stream 118. In one embodiment, the mist movement device 134 may move the mist 114 at flow rates in the range of about 10 CFM to about 100 CFM, or about 25 CFM to about 50 CFM, for example.

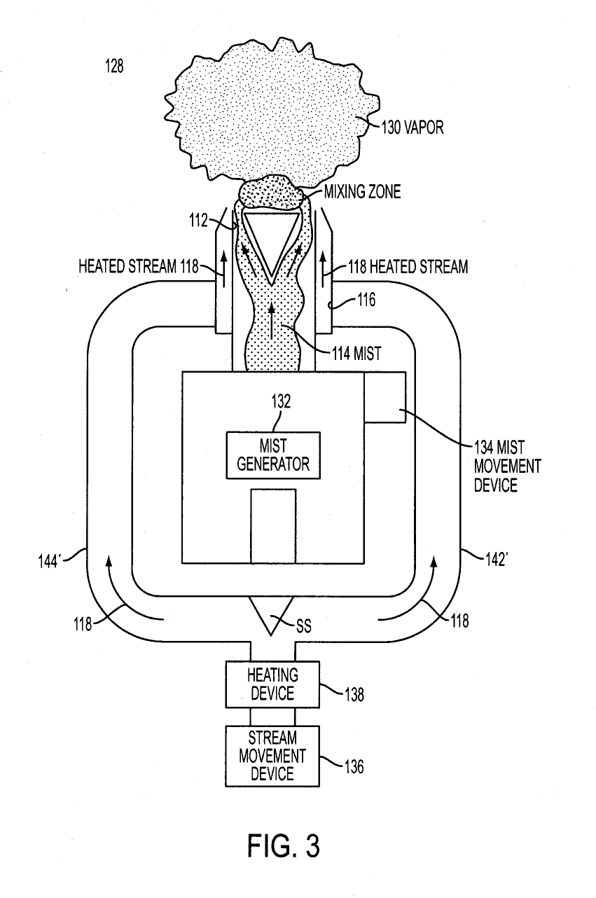

In one embodiment, referring to FIG. 2A, the at least one stream movement device 136 may comprise a fan, a blower, and/or other suitable device, for example. In one embodiment, the stream movement device 136 may be an about 50 CFM to about 500 CFM, or about 100 CFM to about 300 CFM blower, which is commercially available from Dayton. The at least one stream movement device 136 may be configured to draw air into and through the apertures in the housing, and move or blow the air toward, over, and/or through the at least one heating device 138 and into the second conduit 116 as the heated stream 118. The heated stream 118 may help distribute the vapor more uniformly within the environment 128. In other various embodiments, the at least one stream movement device 136 may be supplied with, connected to, or be in fluid communication with an independent source of gas, such that the gas may be moved or blown by the at least one stream movement device 136 toward, over, and/or through the at least one heating device 138 and eventually forced into the second conduit 116 as the heated stream 118. In one embodiment, referring to FIG. 3, only one stream movement device 136 may be provided. Also, in other various embodiments, more than two stream movement devices may be provided. In one embodiment, the at least stream movement device 136 may move the heated stream 118 or an unheated stream at any suitable velocity or flow rate. In other various embodiments, the flow rate may be about 100 CFM to about 300 CFM, which may correspond to about 30 ft/s to about 90 ft/s in an about 2-inch diameter conduit. The flow rate of the heated stream 118 may be constant, continuously variable, and/or intermittent in various applications.

In one embodiment, referring still to FIG. 2A, the at least one heating device 138 may comprise a burner, an electrical heater, a water heater, a heat exchanger, heat tape, and/or any other suitable heat source known to those of skill in the art. In one embodiment, the at least one heating device 138 may be an about 500 watts to about 4000 watts, or about 1000 watts to about 2000 watts heater, which is commercially available from Omega Engineering. In one embodiment, the heating device 138 may comprise heat tape, for example. The heat tape may be wrapped around a portion of the various decontamination apparatuses to heat the heated stream. In various embodiments, the at least one heating device 138 may raise the temperature of the unheated stream about 30 to about 150 degrees C., or about 40 to about 100 degrees C., about 50 to about 80 degrees C., and/or about 60 to about 70 degrees C., for example. The proper temperature of the heated stream should be suitably scaled by the mist rate, for example. In one embodiment, referring to FIG. 3, only one heating device 138 may be provided, for example. Also, in other embodiments, more than two heating devices may be provided.

In various embodiments, referring to FIG. 2A, the at least one mist generator 132 and the mist movement device 134 may be in fluid communication with each other and with the first conduit 112 and the first outlet 122. In such an embodiment, the mist 114 may be produced by the at least one mist generator 132 and moved or blown by the at least one mist movement device 134 (which, in other embodiments, may merely be a vacuum as discussed herein) into the first conduit 112 and out of the first outlet 122. In one embodiment, the at least one stream movement device 136 may be in fluid communication with an aperture in the housing or a source of gas, such that the stream movement device 136 may draw air or gas into the housing. Once the air or gas is drawn into the housing, the at least one stream movement device 136 may blow or move the air or gas into a third conduit 142 and a fourth conduit 144. The at least one heating device 138 may be positioned in thermal communication with or within the third conduit 142 and the fourth conduit 144, such that the air or gas may be heated to an appropriate temperature to create the heated stream 118. A suitable temperature range of the heated stream 118 after exiting or passing over the heating device 138 may be properly scaled by the mist rate. The third conduit 142 and the fourth conduit 144 may be in fluid communication with the second conduit 116 through bores in a sidewall 146 of the second conduit 116. The third conduit 142 and the fourth conduit 144 may each comprise a heated stream outlet 148 in fluid communication with the bore in the second conduit 116, such that the heated stream 118 may be passed into the second conduit 116 by the heated stream outlets 148 of the third conduit 142 and the fourth conduit 144. In one embodiment, the sidewall 146 of the second conduit 116 may comprise an arcuate portion, wherein the heated stream outlets 148 of the third conduit 142 and the fourth conduit 144 are tangentially positioned with respect to the arcuate portion of the sidewall 146. In one embodiment, the second conduit 116 comprises a longitudinal axis. A portion of the third conduit 142 proximate to the heated steam outlet 148 and a portion of the fourth conduit 144 proximate to the heated stream outlet 148 may each be perpendicular to, substantially perpendicular to, or transverse to the longitudinal axis of the second conduit 116.

By causing the heated stream 118 to enter the second conduit 116 in a direction substantially perpendicular to, or perpendicular to, a longitudinal axis of the first conduit 112, and tangentially with respect to an arcuate sidewall of the second conduit 116, a swirling flow of the heated stream 118 may be created within the second conduit 116. Such a swirling flow may enhance the entrainment of the mist 114 with the heated stream 118 outside of the first outlet 122 and the second outlet 124. Such a swirling flow may also increase the turbulence of the heated stream 118, again providing for better mixing with or entrainment of the mist 114.

In one embodiment, referring to FIGS. 2B and 2C, another decontamination apparatus 100′ is illustrated. In such an embodiment, the mist generator 132 may be configured to produce the mist 114. The mist 114 may be received in a first conduit 112′. The at least one stream movement device 136 may be configured to produce a stream. A portion of the stream may be received in a second conduit 142′ and a portion of the stream may be received in a third conduit 144′. In one embodiment, the third conduit 144′ may be eliminated and the second conduit 142′ may be configured to receive the entire stream. The stream may be heated by the heating devices 138 positioned in, or in thermal contact with, the second conduit 142′ and the third conduit 144′. In one embodiment, heat tape may be used in place of the heating devices 138. In such an embodiment, the heat tape may be wrapped around portions of the second conduit 142′ and/or the third conduit 144′. The first conduit 112′ may comprise a first outlet 113′ configured to pass the mist 114 therethrough. The second conduit 142′ may comprise a second outlet 115′ configured to pass a portion of the heated stream 118 therethrough, and the third conduit 144′ may comprise a third outlet 117′ configured to pass a portion of the heated stream 118 therethrough. The second outlet 115′ and the third outlet 117′, because of their positioning with respect to the first conduit 112′, as illustrated in FIG. 2C, may create a swirling flow in the mixing zone. Owing to the positioning of the first outlet 113′, the second outlet 115′, and optionally the third outlet 117′, the heated stream 118 may be mixed or turbulently mixed with the mist 114 outside of the first outlet 113′, the second outlet 115′, and optionally the third outlet 117′ to form a vapor 130 for decontamination of an environment. In such an embodiment, the vapor 130 may be produced at least partially outside of the decontamination apparatus 100′. In various embodiments, a mixing zone may be formed at least partially within the decontamination apparatus 100′ and at least partially outside of the decontamination apparatus 100′.

In one embodiment, referring to FIG. 3, one stream movement device 136 and one heating device 138 may be provided. In such an embodiment, a third conduit 142′ may be joined with and may be in fluid communication with a fourth conduit 144′, such that the heated stream 118 may be passed through or over the heating device 138 and then moved into the third conduit 142′ and the fourth conduit 144′. In one embodiment, a stream splitter (labeled “SS”) may be positioned at or proximate to the intersection of the third conduit 142′ and the fourth conduit 144′ to help direct about half of the heated stream 118 into the third conduit 142′ and about half of the heated stream 118 into the fourth conduit 144′. The third conduit 142′ and the fourth conduit 144′ may be in fluid communication with the second conduit 116 similar to that described above. In one embodiment, heat tape may be used in place of the heating device 138. In such an embodiment, the heat tape may be wrapped around portions or the entire third conduit 142′ and/or the fourth conduit 144′. In various embodiments, the heat tape may also be wrapped around portions or the entire second conduit 116.

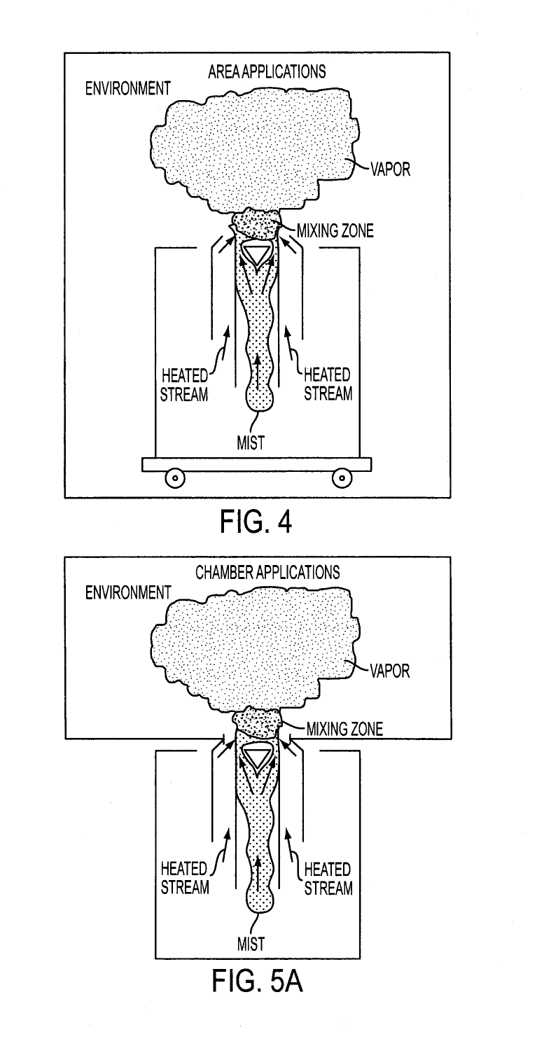

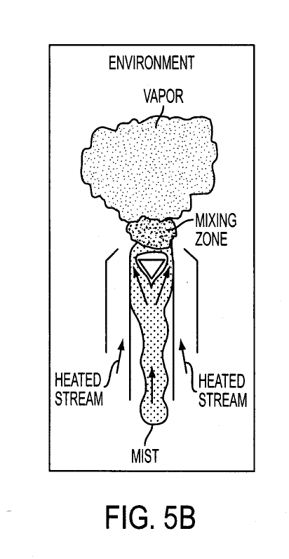

In one embodiment, the decontamination apparatuses of the present disclosure may be used in area applications (FIG. 4) or in chamber applications (FIG. 5A and FIG. 5B). Referring to FIG. 4, in an area application, the decontamination apparatus may be pushed or rolled into an environment or other area in need of decontamination. In various embodiments, the decontamination apparatus may be positioned on a cart or have rollers attached thereto so that it is portable and may be moved from one area requiring decontamination to another. Once the vapor is produced in the environment by the decontamination apparatus and once a sufficient period of time has passed such that the vapor may act upon surfaces or objects within the environment, the decontamination apparatus may be removed from the environment. In various instances, the environment to be decontaminated may be sealed. Referring to FIG. 5A, in a chamber application, the decontamination apparatus may be in fluid communication with a decontamination chamber, such as a decontamination chamber for decontamination of medical instruments or other objects, for example. Although the decontamination apparatus is illustrated in FIG. 5A as being attached to the chamber, those of skill in the art will understand that the decontamination apparatus may not be attached to the chamber, but instead may be in sealed fluid communication with the chamber. In any event, the decontamination apparatus may cause vapor to be produced in the chamber or the environment of the chamber, as illustrated in FIG. 5B.

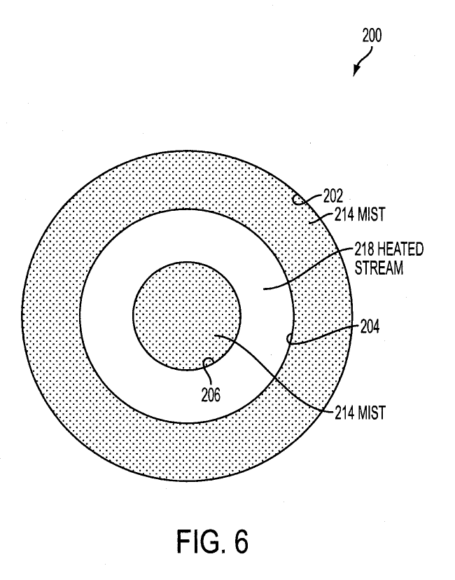

In one embodiment, referring to FIG. 6, a schematic view of another configuration of a decontamination apparatus 200 is disclosed. In such an embodiment, only a top view of outlet portions of the decontamination apparatus is illustrated for simplicity. The decontamination apparatus 200 comprises a first conduit 202 configured to receive a mist 214, a second conduit 204 configured to receive a heated stream 218, and a third conduit 206 configured to received a mist 214. The mist 214 may be entrained in and/or mixed with the heated stream 218 to produce a vapor. The mist 214 may be supplied to the first conduit 202 and the third conduit 206 by a single mist generator or by two or more mist generators. The heated stream 218 may be supplied to the second conduit 204 similar to that described above. The mist 214 may be entrained into the heated stream 218, after the mist 214 and the heated stream 218 exit the first, second, and third conduits 202, 204, and 206, because of the radial negative pressure gradient on either side of the heated stream 218, caused by the movement or flow of the heated stream 218. In one embodiment, the first, second, and third conduits 202, 204, and 206 may be concentric. In one embodiment, the heated stream 218 may create a swirling flow as it exits the second conduit 204. In other various embodiments, mist diverters (not illustrated) may be positioned proximate to, at least partially in, or in an outlet of the first conduit 202 and an outlet of the third conduit 206 to divert the mist 214 into the heated stream 218 exiting the outlet of the second conduit 204. In still other embodiments, a heated stream diverter may be positioned proximate to, at least partially in, or in an outlet of the second conduit 204 to divert the heated stream 218 into the mist 214 flowing out of the first conduit 202 and the mist 214 flowing out of the third conduit 206. In various embodiments, the flow of the mist 214 through the first conduit 202 and the third conduit 206 may be caused by the movement of the heated stream 218 creating a negative radial pressure in the first conduit 202 and the third conduit 206. In one embodiment, the mist 214 in the first conduit 202 may have the same or a different flow rate than the mist 214 in the third conduit 206. In various embodiments, the mist 214 in the first conduit 202 may have the same or a different composition as the mist 214 in the third conduit 206. In one embodiment, the mist 214 in the first conduit 202 may exit the first conduit 202 at the same or a different time as the mist 214 in the third conduit 206, for example. In various embodiments, a heated stream may be provided in the first conduit 202 and the third conduit 206 and a mist may be provided in the second conduit 204, for example.

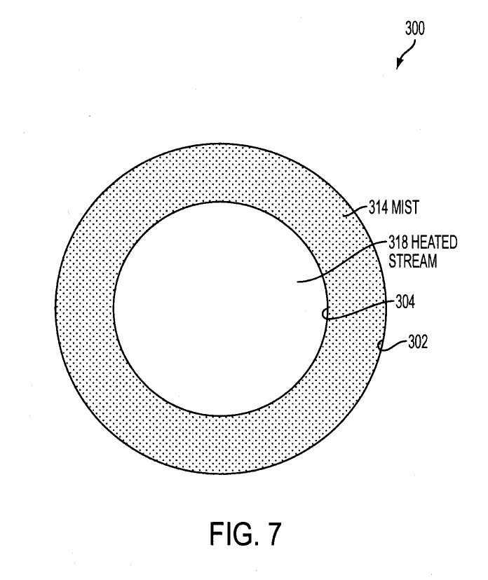

In one embodiment, referring to FIG. 7, a schematic view of another configuration of a decontamination apparatus 300 is disclosed. In such an embodiment, only a top view of outlet portions of the decontamination apparatus 300 is illustrated for simplicity in illustration. The decontamination apparatus 300 may comprise a first conduit 302 configured to receive a mist 314 and a second conduit 304 configured to receive a heated stream 318. In such an embodiment, the mist 314 may be entrained in and/or mixed with the heated stream 318 similar to that described above to create a vapor.

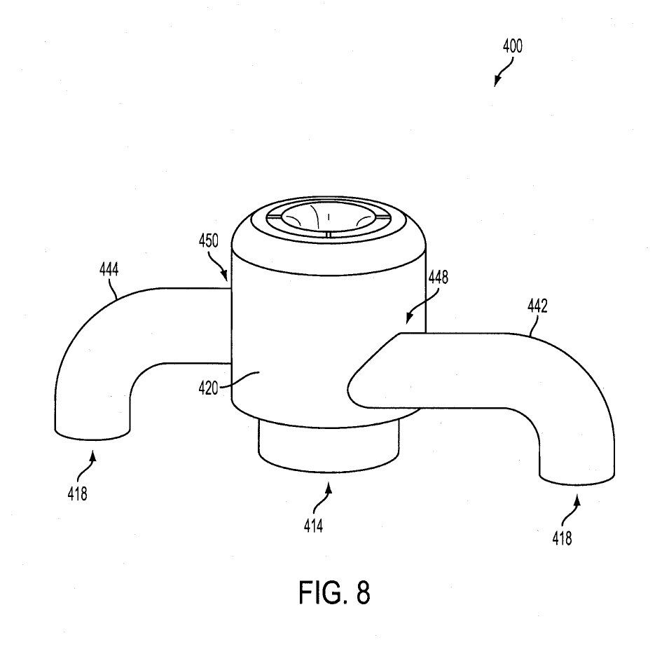

In one embodiment, referring to FIG. 8, a decontamination apparatus 400 may comprise a first conduit that is configured to receive at least one mist stream 414 and a second conduit configured to receive two heated streams 418. The heated streams 418 may enter the second conduit through bores in a sidewall 420 of the second conduit. A third conduit 442 comprising a heated stream inlet 448 and a fourth conduit 444 comprising a heated stream inlet 450 may be attached to the sidewall 420 comprising an arcuate portion tangentially, such that the heated stream 418 may be swirled within the second conduit. Such swirling of the heated stream 418 may provide for better entrainment of the mist 414 outside of the outlet portions of the first and second conduits.

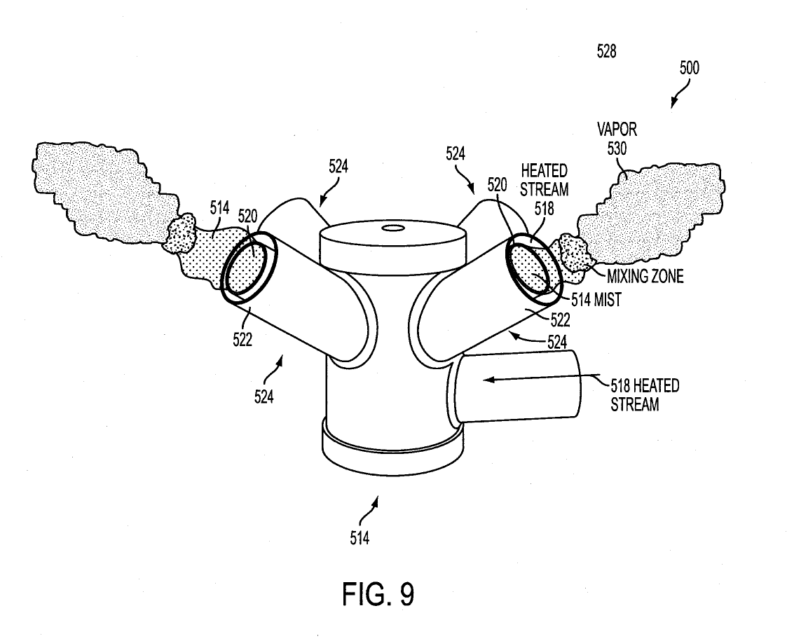

In one embodiment, referring to FIG. 9, a multi-port decontamination apparatus 500 may comprise a first conduit that is configured to receive at least one mist stream 514 from a mist generator and a second conduit configured to tangentially receive a heated stream 518. The first conduit is in fluid communication with a plurality of outlet tubes 520 configured to channel the mist 514 to an environment 528 to be decontaminated. The second conduit is in fluid communication with a plurality of outlet tubes 522 configured to channel the heated stream 518 to the environment 528 to be decontaminated. In one embodiment, one of the outlet tubes 520 and one of the outlet tubes 522 may form a port 524 of the multi-port decontamination apparatus 500. The port 524 may be used to expel the mist 514 and the heated stream 518 into the environment 528 to be decontaminated to form a vapor 530.

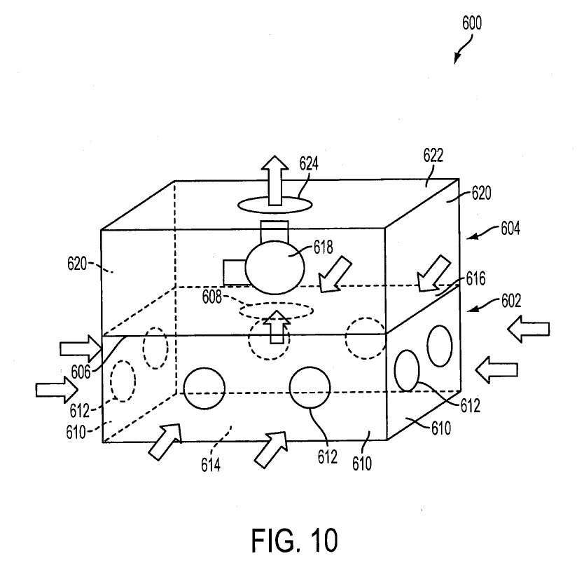

In various embodiments, referring to FIG. 10, a portion of a housing of a decontamination apparatus, an inlet assembly, or an attachment to a decontamination apparatus (hereafter “windbox 600”) is disclosed. In one embodiment, the windbox 600 may comprise a first section 602 and a second section 604. The first section 602 may comprise a top wall 606 comprising at least one aperture 608 defined therein, sidewalls 610 each comprising at least one aperture 612 therein, and a bottom wall 614, which may comprise apertures therein, although such apertures are not illustrated in FIG. 10. The second section 604 may comprise a bottom wall 616 that is the same component as the top wall 606, a gas movement device 618 positioned therein, side walls 620, and a top wall 622 defining at least one aperture 624 therein. In one embodiment, the windbox 600 may be positioned on or form a bottom portion, or other portion, of a decontamination apparatus, such as on the decontamination apparatus of FIG. 4, for example. When the gas movement device 618 is actuated, it may create a negative pressure within the first section 602 causing air to rush into the apertures 612 or other apertures in the first section 602. The air will then be sucked into the second section 604 through the aperture 608 in the top wall 606 and then may be blown through the aperture 624 in the top wall 622. Those of skill in the art will recognize that the windbox 600 may take on various other configurations, shapes, and/or aperture patterns while still accomplishing a similar result and function. In one embodiment, the first section 602 may comprise a uniform pattern of apertures or slots on the sidewalls 610, for example. The various apertures in the sidewalls 610 of the first section 602 may have similar sizes and shapes or different sizes and shapes. The apertures 608 and 624 may also have any suitable size and shape.

In various embodiments, the windbox 600 may allow a decontamination apparatus to draw air into itself from multiple directions, thereby causing a circulation of air in an environment, for example. As air is drawn into the windbox 600, a negative pressure may be created where that air was positioned in the environment, thereby causing air in the environment to move toward the windbox 600. The decontamination apparatus may expel mist and a heated stream from a top portion thereof, for example, and the windbox 600 may be positioned on or be attached to a bottom portion of the decontamination apparatus. As such, when vapor is created by the mixing of the mist and the heated stream, the vapor may diffuse throughout the environment owing to the circulation caused by the use of the windbox 600. Stated another way, the windbox 600 may be used to achieve more uniform vapor dispersion within the environment.

In one embodiment, a decontamination method of producing a vapor is provided by the present disclosure. The method may be accomplished using one of the decontamination apparatuses described herein or by using another decontamination apparatus. The decontamination method may comprise the steps of generating a mist from a mist generator, generating a stream from a stream movement device, and heating the stream by a heating device. The generating of the stream step may comprise creating a vacuum within a box-type inlet assembly, wherein the box-type inlet assembly may define a plurality of ports therein, and wherein the ports may be open to the environment. The decontamination method may also comprise flowing the mist through a first conduit comprising a first outlet and flowing the heated stream through a second conduit comprising a second outlet. The first outlet may be positioned proximate to the second outlet. The decontamination method may also comprise mixing, or turbulently mixing, the mist with the heated stream proximate to the first outlet and the second outlet to form a mixing zone. At least a portion of the mixing zone may be outside of the decontamination apparatus or, in other embodiments, all of the mixing zone may be outside of the decontamination apparatus. The method may also comprise producing vapor by evaporating the mist with the heated stream and decontaminating at least a portion of an environment with at least a portion of the vapor.

In one embodiment, the method may comprise projecting the mist and the heated stream into an environment to be decontaminated, wherein the mist and the heated stream are mixed while in the environment to produce a vapor. In other various embodiments, a portion of the mist and a portion of the heated stream may be mixed while within the decontamination apparatus and then flowed, moved, or blown through an outlet tube or conduit open to the environment into the environment. In any event, the vapor may be formed using the same mixing steps or turbulent mixing steps.

In one embodiment, although the stream has been discussed herein as being heated, the mist may also be heated with a suitable heating device. In various embodiments, both the mist and the stream may be heated, while in other embodiments, only the mist may be heated.

Notwithstanding that the numerical ranges and parameters setting forth the broad scope of the disclosure are approximations, the numerical values set forth in the example embodiments are reported as precisely as possible. Any numerical value, however, inherently contains certain errors necessarily resulting from the standard deviation found in their respective testing measurements. Furthermore, when numerical ranges of varying scope are set forth herein, it is contemplated that any combination of these values inclusive of the recited values may be used. The terms “one,” “a,” or “an” as used herein are intended to include “at least one” or “one or more,” unless otherwise indicated.

While particular non-limiting embodiments of the present disclosure have been illustrated and described, those of skill in the art will recognize that various other changes and modifications may be made without departing from the spirit and scope of the present disclosure. It is therefore intended to cover in the appended claims all such changes and modifications that are within the scope of the present disclosure.

What is claimed is:

1. A decontamination apparatus comprising:
a first conduit in fluid communication with a mist generator and configured to receive a mist;
a second conduit in fluid communication with a heated stream movement device and configured to receive a heated stream;
wherein the first conduit comprises a first outlet configured to pass the mist therethrough, wherein the second conduit comprises a second outlet configured to pass the heated stream therethrough, wherein the first outlet is positioned proximate to the second outlet, and wherein at least a portion of the mist evaporates into a vapor for decontamination of an environment when mixed with the heated stream outside of the first outlet, the second outlet, and the decontamination apparatus.

2. The decontamination apparatus of claim 1, wherein the first conduit and the second conduit both comprise annular portions.

3. The decontamination apparatus of claim 1, comprising a mist diverter positioned at least partially within the first conduit proximate to the first outlet.

4. The decontamination apparatus of claim 3, wherein the mist diverter is conical-shaped.

5. The decontamination apparatus of claim 1, wherein the second outlet surrounds the first outlet, and wherein the second outlet comprises a heated stream diverter angled toward the first outlet to allow the heated stream to be turbulently mixed with the mist outside of the first outlet and the second outlet.

6. The decontamination apparatus of claim 1, wherein the first outlet surrounds the second outlet.

7. The decontamination apparatus of claim 1, comprising:
a mist generator configured to generate the mist; and
a mist movement device in fluid communication with the mist generator and configured to move the mist into the first conduit.

8. The decontamination apparatus of claim 1, comprising a third conduit, a fourth conduit, and a heated stream movement device, wherein the third conduit is in fluid communication with the heated stream movement device and is in fluid communication with the second conduit, wherein the third conduit is configured to receive a portion of the heated stream, wherein the fourth conduit is in fluid communication with the heated stream movement device and is in fluid communication with the second conduit, and wherein the fourth conduit is configured to receive a portion of the heated stream.

9. The decontamination apparatus of claim 8, wherein the second conduit comprises a longitudinal axis, wherein a portion of the third conduit proximate to a heated stream outlet of the third conduit is substantially perpendicular to the longitudinal axis of the second conduit, and wherein a portion of the fourth conduit proximate to a heated stream outlet of the fourth conduit is substantially perpendicular to the longitudinal axis of the second conduit.

10. The decontamination apparatus of claim 8, wherein the third conduit comprises a heated stream outlet in fluid communication with the second conduit, wherein the second conduit comprises a sidewall comprising an arcuate portion, and wherein the heated stream outlet is tangentially positioned with respect to the arcuate portion of the sidewall.

11. The decontamination apparatus of claim 1, wherein the first conduit and the second conduit each comprise a flexible portion configured to provide the mist and the heated stream to a particular area within the environment for decontamination of the area.

12. The decontamination apparatus of claim 1, comprising a box-type inlet assembly defining a plurality of apertures therein, wherein the apertures are open to the environment.

13. A decontamination apparatus comprising:
a first conduit configured to receive a mist from a mist generator;
a second conduit configured to receive a heated stream from a stream movement device;
a first outlet at an end of the first conduit, wherein the first outlet is configured to pass the mist therethrough; and
a second outlet at an end of the second conduit, wherein the second outlet is configured to pass the heated stream therethrough such that the heated stream is mixed with the mist outside of the first outlet and the second outlet to form a vapor for decontamination of an environment.

14. The decontamination apparatus of claim 13, comprising a third conduit configured to receive a portion of the heated stream from the stream movement device, a third outlet at an end of the third conduit, wherein the third outlet is configured to pass the portion of the heated steam therethrough such that the portion of the heated stream is mixed with the mist outside of the first outlet and the third outlet to form a vapor for decontamination of the environment.

15. The decontamination apparatus of claim 13, wherein the first outlet and the second outlet are positioned on the decontamination apparatus such that the heated stream is turbulently mixed with the mist outside of the first outlet and the second outlet to form the vapor.

16. The decontamination apparatus of claim 13, wherein a portion of the vapor is formed outside of the decontamination apparatus by mixing a portion of the heated stream with the mist.

17. A decontamination method using a decontamination, apparatus, the method comprising:
generating a mist from a mist generator;
generating a stream from a stream movement device;
heating the stream by a heating device;
flowing the mist through a first conduit comprising a first outlet;
flowing the heated stream through a second conduit comprising a second outlet, wherein the first outlet is positioned proximate to the second outlet;
mixing the mist with the heated stream proximate to the first outlet and the second outlet to form a mixing zone, wherein at least a portion of the mixing zone is outside of the decontamination apparatus;
producing vapor by evaporating the mist with the heated stream; and
decontaminating at least a portion of an environment with at least a portion of the vapor.

18. The decontamination method of claim 17, wherein the mixing is accomplished by turbulently mixing the mist with the heated stream outside of the decontamination apparatus.

19. The decontamination method of claim 17, comprising producing the vapor in the environment to be decontaminated.

20. The decontamination method of claim 17, wherein the generating of the stream comprises creating a vacuum within a box-type inlet assembly, wherein the box-type inlet assembly defines a plurality of apertures therein, and wherein the plurality of apertures are open to the environment.
